(19) United States
(12) Patent Application Publication
(10) Pub. No.: US 2006/0059043 A1
(43) Pub. Date: Mar. 16, 2006

(54) Method and system to provide wireless access at a reduced rate

(76) Inventors: Wesley T. Chan, Mountain View, CA (US); Shioupyn Shen, Mountain View, CA (US); Georges Harik, Mountain View, CA (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 10/941,274

(22) Filed: Sep. 14, 2004

(51) Int. Cl. G06Q 30/00

(52) U.S. Cl. 705/14

(57) ABSTRACT

Methods and system for providing wireless access at a reduced rate. In one embodiment, access to a WAP is provided to an end-user at a rate subsidized by a first entity. The first entity includes advertisements in an end-user view.

### FIELD OF INVENTION

The field of invention relates generally to wireless data communication, and more particularly, to provide wireless access at a reduced rate.

### BACKGROUND

Mobile computer users are able to enjoy wireless Internet access at various wireless access points (WAPs), commonly referred to as WiFi access points. The WiFi access points are wireless access points that are compatible with IEEE 802.11, as certified by the Wireless Fidelity (WiFi) Alliance.

Typically, WiFi operators deploy WiFi access points at high traffic locations to meet the need of mobile users. The cost of WiFi deployment, however, is relatively high and WiFi operators charge their customers accordingly to recoup their investment and make some profits.

In particular, much of the expense in providing WiFi access is related to setting up the infrastructure to charge for the wireless Internet access. For example, a WiFi provider typically needs to maintain user accounts, user authorizations, usage metering, billing, support, and maintenance. In addition, expenses further include the monthly cost of connecting the access points to Internet, powering them, hosting them, and servicing them as well.

The relative high price for an end-user to access a WiFi access point is typically not a problem for executives or road warriors. However, many casual mobile computer users may be deterred from using WiFi Internet access because they typically only need it once in a while and are reluctant to pay a premium price for their occasional needs.

As a result, the gap between what WiFi operators charge and what casual mobile users are typically willing to pay is relatively significant. Therefore, WiFi Internet access as an industry has experienced a rather slow start.

Thus, what is desired is a method or system that helps overcome one or more of the above-described limitations.

### SUMMARY

In one embodiment, access to a WAP is provided to an end-user at a rate subsidized by a first entity. The first entity includes advertisements in an end-user view.

### BRIEF DESCRIPTION OF THE DRAWINGS

FIG. 1 presents a diagram illustrating an overview in accordance with one embodiment.

FIG. 2 presents a flow diagram describing the process to provide wireless access at a reduced rate, in accordance with one embodiment.

FIG. 3 presents a diagram of an advertisement displayed, in accordance with one embodiment.

FIG. 4 presents flow diagram describing the process of providing traffic through a first entity, in accordance with one embodiment.

FIG. 5 presents a system architecture diagram, in accordance with one embodiment.

### DETAILED DESCRIPTION

Overview of One Embodiment

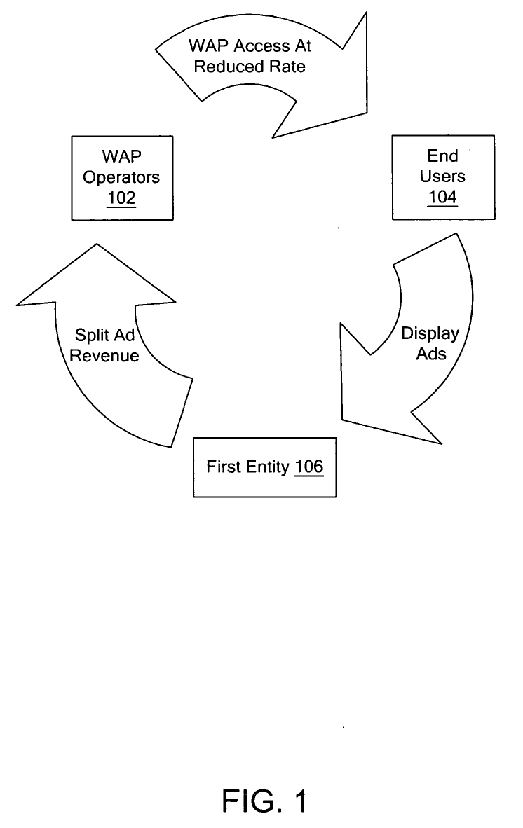

A method and system for providing wireless access at a reduced rate, is described. FIG. 1 presents a diagram illustrating an overview in accordance with one embodiment. A wireless access point (WAP) operator 102 provides access to an end-user 104 at a rate subsidized by a first entity 106. The first entity 106 includes advertisements in a view provided to an end-user 104 that has accessed the WAP. In one embodiment, the first entity 106 provides a portion of advertisement revenue to the WAP operator 102.

Reference throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Description of Process

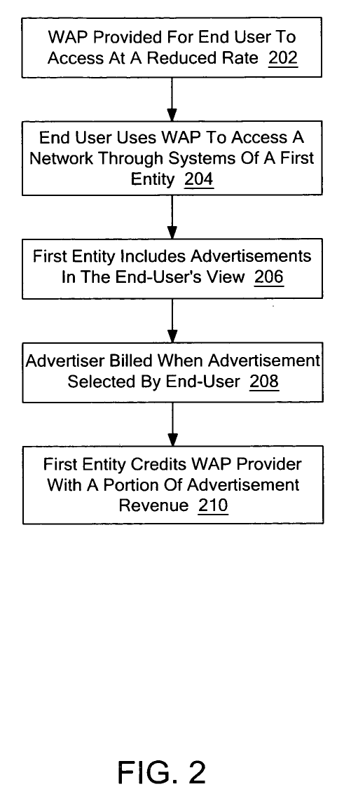

FIG. 2 presents a flow diagram describing the process to provide wireless access at a reduced rate, in accordance with one embodiment. As illustrated, in stage 202 a WAP operator (also referenced herein as a WiFi provider or operator), provides a wireless access point for end-users to access. In one embodiment, end-users are able use the WAP free of charge to gain access to the Internet. In alternate, embodiments, the end-users pay a rate to the WAP operator that is reduced relative to a rate typically charged for access to a conventional WAP or WiFi hotspot.

In stage 204, an end-user uses the WAP to access a network by passing through systems of a first entity, which provide a gateway to the destination network. In one embodiment, the destination network may be the Internet. In alternative embodiments, networks other than the network may be accessed.

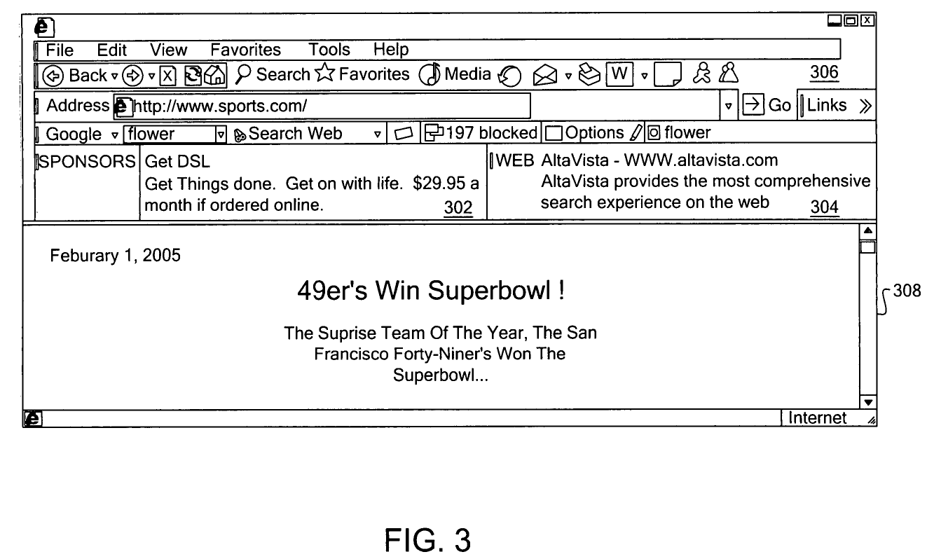

In stage 206, the first entity includes advertisements in the end-user's view. For example, as illustrated in the example view of FIG. 3, the advertisements 302-304 are provided in a toolbar 306 displayed on an end-user's view 308, in accordance with one embodiment. The toolbar includes a row or column of on-screen buttons used to activate functions in an application, such as a web browser. In alternative embodiments, the advertisements from the first entity may be placed in alternative locations, such as within (or to the side of) content accessed by, or provided to the end-user.

The advertisements may continue to be served at a pace that is independent of the end user's activity. For example, in one embodiment, the advertisements placed in the end user's view by the first entity, can continue to be refreshed regardless of whether a web page, or other, being viewed is updated. The advertisements may also be served during page transitions.

In addition, the manner that the advertisements are served to the end users, in one embodiment, is independent of the type of network traffic that passes through the gateway of the first entity. For example, is an end user of WAP has accessed the Internet to perform instant messaging IM activity, the first entity may serve advertisements to the end users to be placed in the end user's tool bar, or web page content down loaded.

The process used by the first entity to select advertisements to be placed in the view of the end user may vary based on implementation. For example, the process used to select the advertisements may be based on such factors as the geographical location of the respective WAP, the operations of the entity providing the WAP, a profile of the end users accessing the WAP, a profile of the WAP, content accessed by end users of the respective, and other network/Internet activity.

Additional embodiments for selecting advertisements to be placed by the first entity into the end users' view, are described in more detail in U.S. patent application entitled Method and System To Provide Advertisements Based on Wireless Access Points, filed on Sep. 14, 2004, assigned Ser. No. ______, and U.S. patent application entitled Method and System To Profile Wireless Access Points, filed on ______, assigned Ser. No. ______, both of which are incorporated herein by reference.

In one embodiment, the advertisements provided by the first entity may be presented with a hyperlink that when selected by an end-user results in additional information being displayed. In one embodiment, in stage 208 when the hyperlink of an advertisement is selected by an end-user, the respective advertiser is billed by the first entity.

In stage 210, the first entity, in turn, credits the WAP provider with a portion of the advertisement revenue. The portion of the revenue may include a flat rate, a percentage of the advertisement revenue, or a combination thereof. In one embodiment, the first entity identifies the WAP to be credited via the Internet protocol (IP) address of the WAP provided by the end-user who has accessed the advertisement.

As a result of receiving a portion of the advertisement revenue, the WAP provider is may cover the expenses of providing the WAP and may recoup a profit, while providing end-users with access to the WAP at a reduced rate.

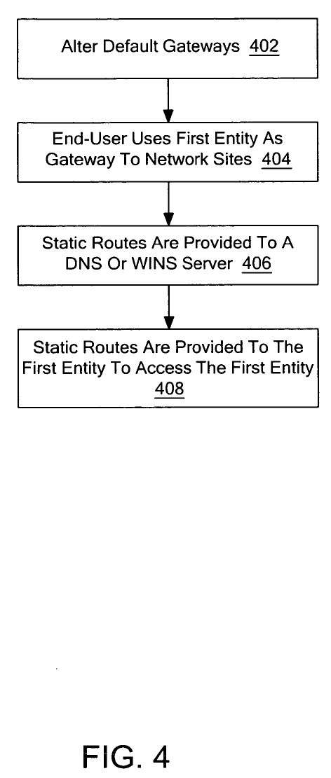

In one embodiment, the WAPs are in effect restricted to tunneling Internet traffic through the first entity to have the first entity include advertisements in a view presented to an end-user of the respective WAPs. FIG. 4 presents a flow diagram describing the process of providing traffic from a WAP to the first entity, in accordance with one embodiment. In stage 402, the default gateways in the routing tables of a WAP may be altered to block all traffic except those configured in static routes.

To access network sites other than those provided with static routes, in stage 404 the end-user uses the systems of the first entity as a gateway. For example, in one embodiment, the end-user either proxies through, or establishes a virtual packet network (VPN) with the systems of the first entity.

In one embodiment, a client application is loaded onto the end-user system. With the client application the end-user is able to either proxy through or establish a VPN with the first entity to access other network sites.

In stage 406, in one embodiment, static routes are provided to a dynamic name systems (DNS) or Windows Internet name service (WINS) server to allow DNS/WINS queries to go through. And, in stage 408, additional static routes are also provided to the first entity's data centers to allow traffic to the first entity's data centers to go through.

Description of System Architecture

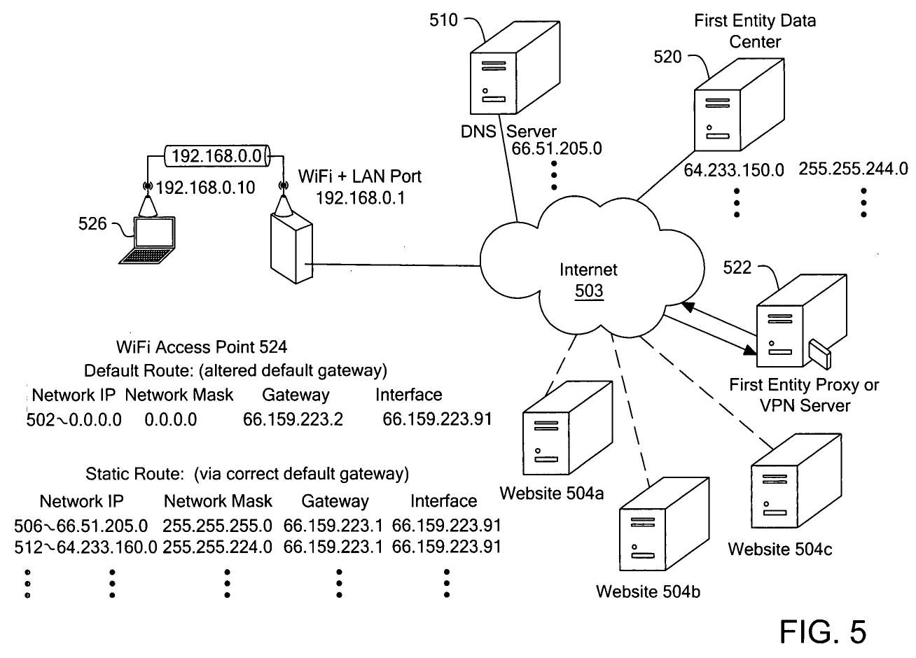

FIG. 5 presents a network diagram illustrating the tunneling of Internet traffic 503 from a WiFi access point 524 through the first entity, in accordance with one embodiment. As illustrated, the default gateway 502 may be altered to block access to other web sites 504a-504c. Static routes 506-508 to a DNS or WINS server 510 may be provided to resolve IP addresses. Static routes 512-518 to the first entity's data centers 520 may also provided so an end-user 526 can reach the first entity without problem.

When an end-user 526 wants to access Internet sites other than those provided with static routes, the end-user 526 may either proxy through, or establishes a virtual packet network (VPN) with the systems 522 of the first entity. As a result, in one embodiment, Internet traffic 503 travels through the first entity prior to an Internet destination.

In alternative embodiments, alternative implementations may be used to tunnel Internet traffic from a WiFi access point through the first entity. For example, some alternative implementations include: having the first entity provide its own WiFi access point; and/or, providing a list of service set identifier-wired equivalent privacy (SSID-WEP) settings to be down loaded by an end-user to connect to any of the listed WiFi access points.

In alternative embodiments, data other than advertisements could be inserted by the first entity into the view presented to the end-user accessing a WAP. For example, the data could in the form of a message, or a static advertisement that does not include a hyperlink. A party that having the message or static advertisement inserted may pay the first entity a flat rate to include the data in the view presented to the end-user. The first entity would share a portion of the revenue collected with the one or more WAPs that provided the end-users with access at a reduced rate.

Furthermore, the processes and architecture described above may be used to provide wireless access at a reduced rate for multiple WAPs, including multiple disparate WAPs.

General Legal Statements

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method comprising:
providing an end-user with access to a wireless access point (WAP) at a rate subsidized by a first entity; and
the first entity including advertisements in an end-user view.

2. The method of claim 1, wherein the first entity is separate from a provider of the WAP.

3. The method of claim 1, wherein the providing includes providing the end-user with wireless access to an Internet.

4. The method of claim 1, wherein the providing the end-user with access to the WAP at the rate subsidized by the first entity includes providing the access to the end-user free of charge.

5. The method of claim 1, further including the first entity providing at least a portion of advertisement revenue to a provider of the WAP.

6. The method of claim 1, further including the first entity providing at least a portion of advertisement revenue to a WAP provider in response to the providing the access to the end-user at a reduced rate.

7. The method of claim 1, further including the first entity providing a portion of advertisement revenue to a WAP provider in response to providing the access to the end-user at a reduced rate, and in further response to the end-user selecting an advertisement included by the first entity.

8. The method of claim 1, further including the first entity providing a WAP provider with one of a fixed fee, and a fixed fee and a portion of advertisement revenue, in exchange for providing the access to the end-user at the reduced rate.

9. The method of claim 5, wherein the providing at least the portion of the advertisement revenue to the WAP provider includes the first entity identifying an Internet protocol (IP) address of a WAP accessed by the end-user that has selected an advertisement provided by the first entity.

10. The method of claim 1, wherein the WAP is a WiFi access point.

11. The method of claim 1, wherein the providing the access further includes providing the access in response to the end-user installing a client application corresponding to the first entity.

12. The method of claim 1, wherein the first entity including advertisements in the end-user view includes providing advertisements in a tool bar of the end-user view.

13. The method of claim 1, wherein the providing an end-user with access to the WAP at a rate subsidized by a first entity, includes providing multiple end-users with access to multiple WAPs at a rate subsidized by the first entity.

14. A method comprising of:
including an advertisement in a view of an end-user accessing a wireless access point; and
providing at least a portion of revenue from the advertisement to a provider of the wireless access point.

15. A method comprising of:
providing an end-user with Internet access to a wireless access point (WAP) at a rate subsidized by a first entity, the first entity separate from a provider of the WAP;
providing the access in response to the end-user installing a client application corresponding to the first entity, the first entity including advertisements in an end-user view;
the first entity providing at least a portion of advertisement revenue to the provider of the WAP in response to the WAP provider providing the access to the end-user at a reduced rate;
the first entity providing the portion of advertisement revenue to the provider in response to the end-user selecting an advertisement included by the first entity; and
the first entity identifying an Internet protocol (IP) address of the WAP accessed by the end-user that has selected the advertisement provided by the first entity.

16. An apparatus comprising:
a means for providing an end-user with access to a wireless access point (WAP) at a rate subsidized by a first entity; and
a means for the first entity including advertisements in an end-user view.

17. An apparatus comprising:
a means for including an advertisement in a view of an end-user accessing a wireless access point; and
a means for crediting at least a portion of revenue from the advertisement to a provider of the wireless access point.

18. A machine readable medium having stored thereon a set of instructions, which when executed, perform a method comprising of:
providing an end-user with access to a wireless access point (WAP) at a rate subsidized by a first entity; and
the first entity including advertisements in an end-user view.

19. A machine readable medium having stored thereon a set of instructions, which when executed, perform a method comprising of:
including an advertisement in a view of an end-user accessing a wireless access point; and
crediting at least a portion of revenue from the advertisement to a provider of the wireless access point.
